(19) United States
(12) Patent Application Publication
(10) Pub. No.: US 2004/0137986 A1
(43) Pub. Date: Jul. 15, 2004

(54) System and method for providing education and awareness of homeless issues

(75) Inventors: Connie Mercer, Lawrenceville, NJ (US); Elizabeth Winter, Lawrenceville, NJ (US)

Correspondence Address: JOHN W. RYAN, C/O DECHERT LLP, PRINCETON PIKE CORPORATION CENTER, P.O. BOX 5218, PRINCETON, NJ, 08543-5218, US

(73) Assignee: HomeFront, Inc.

(21) Appl. No.: 10/342,695

(22) Filed: Jan. 15, 2003

(51) Int. Cl. G06F 19/00

(52) U.S. Cl. 463/42

(57) ABSTRACT

The invention relates to a role playing game having at least one identity card providing information relating to a hypothetical low income individual. The game also includes a plurality of expense cards (e.g., fixed monthly expenses), a plurality of chance cards (variable monthly expenses or income), and a supply of play money having a fictitious cash value. The game play centers around the administration of income and expenses associated with the hypothetical low income individual's life. The chance cards generally include at least instruction (e.g., relating to income or an expense). Game play generally includes drawing a chance card and responding to the instructions. The player also attempts to allocate at least a portion of the play money towards the expense value of the expense cards. The player continues drawing chance cards and attempting to pay expenses until the all of the expenses are paid or the supply of play money is depleted.

The invention relates to the field of educational tools and games. In particular the invention is directed to a role playing game that provides education and awareness of homeless issues.

Various factors have been identified as contributing to homelessness. For example, homelessness and poverty are inextricably linked. Poor people are often unable to pay for housing, food, child care, health care, and education. Difficult choices must be made when limited resources cover only some of these necessities. Typically, housing absorbs a high proportion of income.

Recent surveys suggest that more than 14 million people have incomes that are less than the poverty level. Despite a relative wealth of infromation in the subject of homelessness, current trends also suggest that this situation is not improving. Other contributing factors include a lack of affordable housing, a lack of affordable health care, fewer employment opportunities for large segments of the workforce, and the declining value and availability of public assistance.

The task of providing assistance and support for homeless individuals and families is greatly hampered by misperceptions among the general population with respect to the plight of the homeless. For example, many citizens mistakenly assume that homeless individuals do not work, or that they are lazy, or that they spent money irresponsibly. In light of such misperceptions, fundraising and support efforts are often difficult. Accordingly, there is a need for new and novel systems and methods that provide a mechanism for education and general awareness of homeless issues.

### SUMMARY OF THE INVENTION

In general, the invention is directed to a role playing game in which a player assumes the role of a hypothetical low income (i.e., potentially homeless) individual. The game play centers around the administration of income and expenses associated with the hypothetical low income individual's life. The invention can be implemented in printed form or electronic form.

In its basic form, the invention is directed to a role playing game having at least one identity card providing information relating to a hypothetical low income individual. The invention also includes a plurality of expense cards, a plurality of chance cards, and a supply of play money having a fictitious cash value.

In one aspect of the invention, the identity card provides information related to at least one of the hypothetical low income individual's current employment status, marital status and family status.

In another one aspect of the invention, the expense cards identify fixed expenses associated with a typical month in the life of the hypothetical low income individual. In yet another aspect of the invention, the expense cards identify fixed expenses that are at least one of housing expenses, utility expenses, transportation expenses, child care expenses, health care expenses, food expenses, telephone expenses and miscellaneous expenses. In another aspect of the invention, the expense cards identify fixed expenses that collectively have a value that exceeds the fictitious cash value of the supply of play money.

In yet another aspect of the invention, the chance cards identify variable events associated with a typical month in the life of the hypothetical low income individual. In yet another aspect of the invention, a plurality of the chance cards identify variable expenses that are at least one of mandatory expenses, optional expenses, income and bad news. In yet another aspect of the invention, a plurality of the chance cards identify at least one of income or a discount correlated to fixed expense. In yet another aspect of the invention, a majority of the chance cards identify expenses.

In yet another aspect of the invention, the fictitious cash value of the supply of play money correlates to a typical after tax salary of the hypothetical low income individual.

The invention is also suitable for implementation on a computer system. In this embodiment, the invention includes a computer system operable to present to a user at least one identity card providing information relating to a hypothetical low income individual, a plurality of expense cards, a plurality of chance cards, and a supply of play money having a fictitious cash value. The invention can also be implemented on a data network. In this embodiment, the invention includes at least one server and at least one user network processing device.

The invention also encompasses a method for playing a role playing game. The method includes a) providing at least one identity card providing information relating to a hypothetical low income individual; b) providing a plurality of expense cards each having an associated expense value, and a supply of play money having a fictitious cash value; c) drawing a chance card having at least one instruction and responding to the instruction; d) allocating at least a portion of the play money towards the expense value of at least one expense card; and repeating steps c and d until all of the expense cards have an associated play money allocation or the play money is depleted.

### BRIEF DESCRIPTION OF THE DRAWINGS

FIG. 1 is a pictorial view of a set of game cards and/or tokens in accordance with the invention.

FIG. 2 shows an exemplary identity card in accordance with the invention.

FIG. 3 shows a block diagram of a user PC and web browser and web server in accordance with the invention.

FIG. 4 shows a block diagram user screen for a computer implemented game in accordance with the invention.

### DETAILED DESCRIPTION OF THE INVENTION

FIG. 1 shows a set of game cards and/or tokens in accordance with the invention. In general, the invention is directed to a role playing game in which a player assumes the role of a hypothetical low income (i.e., potentially homeless) individual. The game play centers around the administration of income and expenses associated with the hypothetical low income individual's life.

The invention includes a one or more identity cards 10, a plurality of expense cards 20, a plurality of chance cards 30 and a supply of play money 40. The identity cards 10 include all of the relevant information necessary to define a family profile associated with the hypothetical low income individual's life and family. For example, the identity cards can identify the hypothetical low income individual's current employment status, marital status, family status (e.g., number of children, names and/or photographs) and the like. In a typical example, the family profile includes a hypothetical low income individual who is a single parent with multiple children.

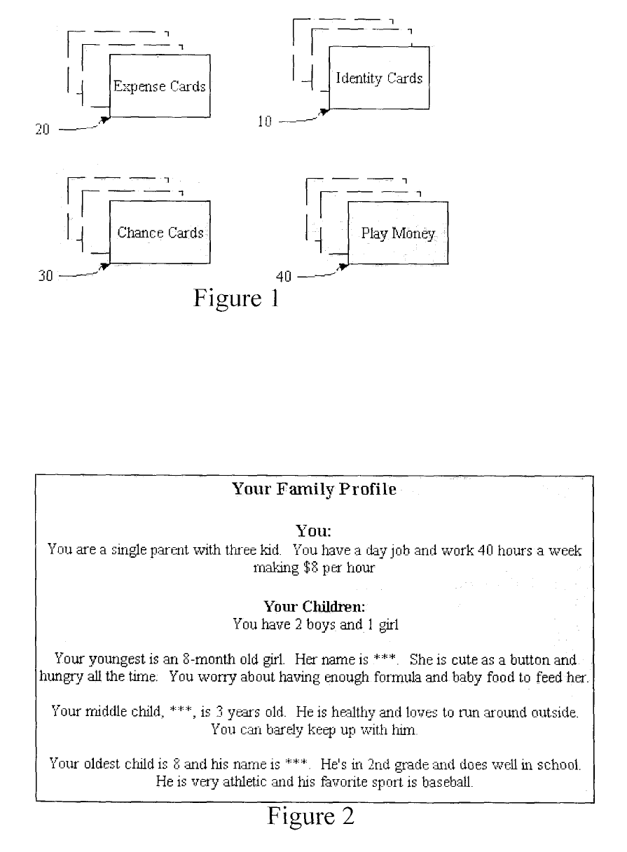

An exemplary identity card is shown in FIG. 2. For purposes of this application, hypothetical children's names have been replaced with “***”. It is understood that hypothetical children's names can be utilized along with associated pictures and the like. This type of infromation is advantageous in that it provides the player with a realistic family profile thus allowing them to more completely identify with the role of the hypothetical low income individual.

The expense cards 20 identify the fixed expenses associated with a typical month in the life of the hypothetical low income individual. The content for an exemplary set of expense cards is shown in Table 1 below:

TABLE 1

| Bill | Total Monthly Cost | Description |
|---|---|---|
| Housing | $900 | 2 bedroom apartment |
| Utility Bill | $106 | Electric - $38 |
| | | Heating gas - $20 |
| | | Cooking gas - $11 |
| | | Water/Sewer - $25 |
| | | Water Heating - $12 |
| | | Total = $106 |
| Transportation | $59 | Bus pass |
| Child Care | $124 | including child care subsidy |
| Health Care | $0 | Health care is covered by |
| | | state run program for low |
| | | income families (e.g., NJ |
| | | Family Care) |
| Food | $167 | Average cost for family |
| | | with three children is $437, |
| | | you get food stamps in the |
| | | amount of $270. |
| Telephone | $20 | Local calls only |
| Miscellaneous | $355 | e.g., clothing, shoes, paper |
| | | products, diapers, cleaning |
| | | products and household |
| | | items. |

It is understood that fewer or additional expenses can be utilized in connection with the invention. It is also understood that the various expenses can be specifically tailored for a particular geographical area (e.g., having varied transportation expenses, food costs, climate and the like).

The chance cards 30 identify variable or unexpected events associated with a typical month in the life of the hypothetical low income individual. The content for an exemplary set of chance cards is shown in Table 2 below:

TABLE 2

| Description | Amount | Type |
|---|---|---|
| Your daughter is growing | $30 | Expense |
| so quickly! She has grown | | |
| out of all of the baby cloths | | |
| you have. Pay $30 for new | | |
| clothes | | |
| Congratulations! After | $360 | Rent deduction |
| being on the waiting list for | | |
| 6 years, you have received a | | |
| Section 8 voucher. You | | |
| now have to pay on $360 | | |
| per month rent. | | |
| Work has been busy lately, | $200 | Income |
| but you can't complain | | |
| because business id good! | | |
| Your boss decided that she | | |
| can give out bonuses this | | |
| year. Your bonus is $200. | | |
| You just enrolled you son | $50 | Child care deduction |
| in the Head Start Program. | | |
| You don't need to pay for | | |
| his child care. Subtract $50 | | |
| from the monthly bill. | | |
| Your son needs $7.50 for a | $7.50 | Expense |
| class trip. Can he go? You | | |
| said no last time. | | |
| You son's class pictures | $18.95 | Expense |
| arrived today and they look | | |
| great! The cheapest | | |
| package you can buy is | | |
| $18.95 | | |
| You have been on the | $0 | Bad news |
| Section 8 waiting list for 6 | | |
| years. You have finally | | |
| received a voucher but you | | |
| cannot find a landlord who | | |
| will accept it. You receive | | |
| no rent deduction. | | |
| You still feel sick. Cough | $12.65 | Expense |
| and cold tablets cost | | |
| $12.65. | | |
| It's summertime and you | $50 | Expense |
| want to take your kids on a | | |
| day trip into Philly. Your | | |
| friend has offered to drive if | | |
| you pay for the gas. Put | | |
| aside $50 this month for | | |
| your whole trip. | | |
| You feel really sick today. | | Question |
| Your boss doesn't provide | | |
| paid sick time. What do | | |
| you do? | | |
| Your son wants to play | $35 | Expense |
| baseball this year. The | | |
| league provides the shirt but | | |
| you must buy his pants and | | |
| a glove. Together they cost | | |
| $35. | | |
| You are out of diapers | $14 | Expense |
| because your daughter has | | |
| had diarrhea. Food stamps | | |
| don't cover diapers or | | |
| wipes. A package of | | |
| diapers is $11 and wipes are | | |
| $3 | | |
| It's your son's birthday. | | Question |
| You need to buy a present | | |
| and a cake. He didn't have | | |
| a party last year and you | | |
| told him he could have 3 | | |
| friends over this year. How | | |
| will you pay for cake and | | |
| ice cream for 7 people. | | |
| Your mom died. She lives | $300 | Expense |
| in Florida and you cannot | | |
| afford a ticket there or to | | |
| miss three days of work. | | |
| Your sister asked if you | | |
| could help out with the | | |
| funeral expenses. You send | | |
| $300. | | |
| It's back to school time. | $80 | Expense |
| Both sons need school | | |
| supplies and new clothes. | | |
| You spend $40 on each | | |
| child. Add $80 to your | | |
| monthly expenses. | | |

The invention also includes a supply of play money 40 having a fictitious cash value. Continuing with the example above, the player is given a supply of play money having a fictitious cash value that correlates to a typical after tax salary of the hypothetical low income individual (e.g., 160 hours per month at $8.00 per hour=$1280, or $1160 after taxes).

Game play proceeds as follows. The player first reviews the identity cards 10 and becomes familiar with their role. The player then takes a supply of play money 40 (e.g., $1160) and all of the expense cards 20. The chance cards 30 are shuffled and placed in a pile face down. The player then begins by sorting through the expense cards and selecting a bill to pay. Then the player selects a chance card and follows the instructions on the chance card. This process is repeated until all of the bills are paid or the player runs put of money.

The invention is unique in that the player is faced with realistic income levels and expenses associated with a hypothetical low income individual. The player is also exposed to a series of difficult decisions that routinely face a low income individual. The content of the expense cars and chance cards are selected to emphasize the difficulty associated surviving on low income wages.

In the example above, the individual amounts of the fixed monthly expenses seem quite reasonable. However, the player will soon notice that the total fixed monthly expenses exceed the hypothetical low income individual's take home pay (e.g., expenses=$1609, income=$1160, a deficit of $449). Thus, it is essentially impossible for the player to successfully pay all the bills. The player will also notice that rent comprises the largest hurdle. A review of the chance cards reveals that the only real possibility for survival comes on the form of a rent subsidy (e.g., Section 8 voucher) and some form of work related bonus. However, the majority of the chance cards identify expenses, as opposed to income. It is also noted that some of the chance cards can identify mandatory expenses as well as optional expenses. For example, the player can be queried as to whether they can incur the expense (e.g., take a sick day, pay for class pictures or a class trip or the like). Some of the chance cards can also identify bad news—as opposed to income or expense (e.g., a Section 8 voucher that cannot be used). It is though this process as the player reads the chance cards and thinks about the issues raised, that they are educated on the issues that face a typical low income individual on a routine basis.

The invention is also suitable for implementation on a computer or computer network. For example, the identity cards, expense cards, chance cards and supply of play money can be implemented in electronic form on a personal computer. In the context of a data network or the Internet, the invention can be implemented with a web server and a user network processing device (instead of running the application directly on the user's computer).

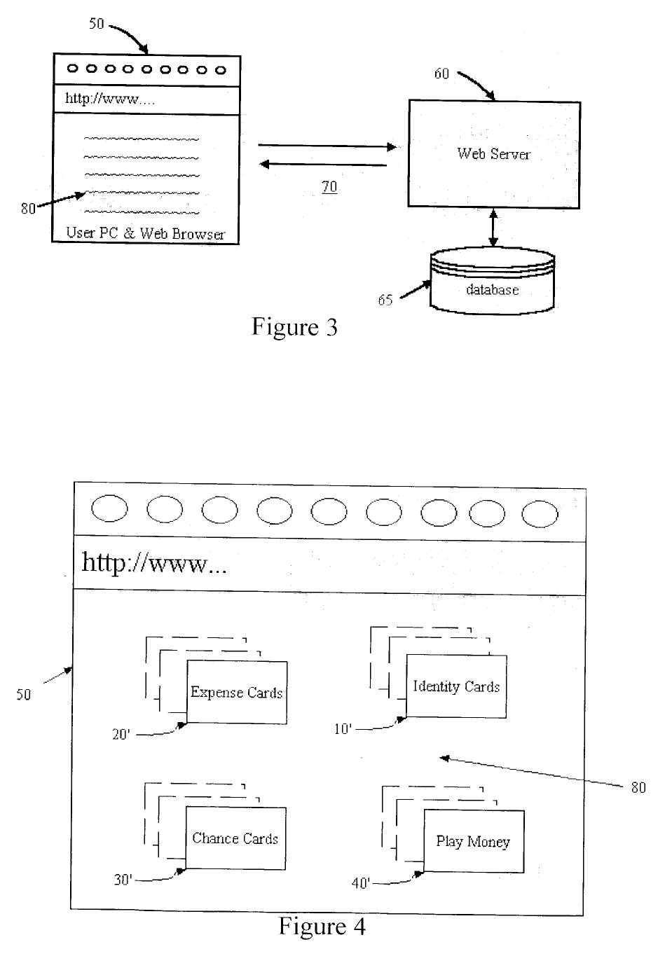

FIG. 3 shows a general block diagram of a user network processing device (user PC and Web Browser 50) and web server 60 in data communication via the Internet in accordance with the invention. In general, the web server 60 is operable to present electronic renditions of the various game elements (e.g., identity cards, expense cards, chance cards and play money) to a user via a web browser.

The terms “present” or “presenting” as used herein are used in their ordinary sense and include displaying or playing audio and/or visual information to a user. The data network generally includes a plurality of nodes such as a user network processing device, content provider server an advertiser server all coupled in data communication. The term “coupled” as recited herein is used in its broadest sense and does not require a physical connection between devices. Two or more devices as disclosed herein are “coupled” so long as data communication between the devices is possible (e.g., hard wired data communication, wireless data communications and the like).

The term “user network processing device” generally refers to any user operable device having access to the data network including but not limited to a personal computer (portable or desktop), personal digital assistant (PDA), Browser phone, 2-way pager or the like. In the context of the Internet, the user network processing device and web server communicate via TCP/IP (Transmission Control Protocol over Internet Protocol).

The user network processing device 50 is operable to transmit a plurality of user requests for resources (e.g., various web pages) and present the resources served in response to the user. The web server 60 is operable to receive the user requests for resources, retrieve (e.g., from database 65) or otherwise generate the requested resource and transmit the requested resource to the user network processing device in response. The term “database” is used herein in its broadest sense (i.e., a collection of information) and is not limited to any particular structure or implementation.

Communications between user PC and Web Browser 50 and web server 60 are generally shown by arrows 70. It is understood that data communications via the Internet often traverse a series of intermediate network nodes prior to reaching the desired destination (e.g., the user or the first provider Web site). Arrows 70 do not suggest a direct physical connection between the user PC and Web Browser 60 and/or various servers and encompass typical Internet communications (a connectionless, best-efforts packet-based system). It is also understood that other data networks using various network protocols are suitable for use in accordance with the invention.

The user PC and Web Browser 50 is operable to accesses the Internet World Wide Web (WWW or Web). The user PC preferably has an associated operating system such as Microsoft Windows or Linux and includes a typical Web Browser such as Netscape Communicator (for Windows or Linux) or Microsoft Internet Explorer, as well as numerous others. The Web Browser assists the user in requesting and displaying Web pages or sites containing desired information. The hardware and software configuration of a user network processing device for Internet access is routine and generally known to those skilled in the art.

The web server 60 is preferably an HTML server hosting a Web site implementing a game in accordance with the invention in electronic form. There are many varieties of commercially or publicly available World Wide Web server software packages which are compatible with the invention all of which can be implemented with commonly available hardware from vendors that are well known to those skilled in the art.

FIG. 3 shows the resources or content 80 provided by the web server 60 in implementing the invention. It is understood that a computer implementation of the invention can take a myriad of forms. FIG. 4 shows a block diagram of a computer implementation in accordance with the invention. In this example, the expense cards 20′, the chance cards 30′ and supply of play money 40′ are depicted graphically on the screen. The paying of bills and/or reading chance cards can be accomplished by clicking the appropriate item or button depicted on the computer screen, dragging items on the screen or the like. The implementation of a computerized version of the invention based on the disclosure herein is well within the scope of those skilled in the art.

While this invention has been described with an emphasis upon preferred embodiments, it will be obvious to those of ordinary skill in the art that variations in the preferred devices and methods may be used and that it is intended that the invention may be practiced otherwise than as specifically described herein.

What is claimed is:

1. A role playing game comprising:
at least one identity card providing information relating to a hypothetical low income individual,
a plurality of expense cards,
a plurality of chance cards, and
a supply of play money having a fictitious cash value.

2. The role playing game of claim 1 wherein the identity card provides information related to at least one of the hypothetical low income individual's current employment status, marital status and family status.

3. The role playing game of claim 1 wherein the expense cards identify fixed expenses associated with a typical month in the life of the hypothetical low income individual.

4. The role playing game of claim 3, wherein the expense cards identify fixed expenses that are at least one of housing expenses, utility expenses, transportation expenses, child care expenses, health care expenses, food expenses, telephone expenses and miscellaneous expenses.

5. The role playing game of claim 3, wherein the expense cards identify fixed expenses that collectively have a value that exceeds the fictitious cash value of the supply of play money.

6. The role playing game of claim 1, wherein the chance cards identify variable events associated with a typical month in the life of the hypothetical low income individual.

7. The role playing game of claim 6, wherein a plurality of the chance cards identify variable expenses that are at least one of mandatory expenses, optional expenses, income and bad news.

8. The role playing game of claim 6, wherein a plurality of the chance cards identify at least one of income or a discount correlated to fixed expense.

9. The role playing game of claim 6, wherein a majority of the chance cards identify expenses.

10. The role playing game of claim 1, wherein the fictitious cash value of the supply of play money correlates to a typical after tax salary of the hypothetical low income individual.

11. A computer implemented role playing game comprising:
a computer system operable to present to a user at least one identity card providing information relating to a hypothetical low income individual, a plurality of expense cards, a plurality of chance cards, and a supply of play money having a fictitious cash value.

12. The computer implemented role playing game of claim 11 wherein the computer system is implemented on a data network and includes at least one server and at least one user network processing device.

13. The computer implemented role playing game of claim 11 wherein the identity card provides information related to at least-one of the hypothetical low income individual's current employment status, marital status and family status.

14. The computer implemented role playing game of claim 11 wherein the expense cards identify fixed expenses associated with a typical month in the life of the hypothetical low income individual.

15. The computer implemented role playing game of claim 14, wherein the expense cards identify fixed expenses that are at least one of housing expenses, utility expenses, transportation expenses, child care expenses, health care expenses, food expenses, telephone expenses and miscellaneous expenses.

16. The computer implemented role playing game of claim 14, wherein the expense cards identify fixed expenses that collectively have a value that exceeds the fictitious cash value of the supply of play money.

17. The computer implemented role playing game of claim 11, wherein the chance cards identify variable events associated with a typical month in the life of the hypothetical low income individual.

18. The computer implemented role playing game of claim 17, wherein a plurality of the chance cards identify variable expenses that are at least one of mandatory expenses, optional expenses, income and bad news.

19. The computer implemented role playing game of claim 17, wherein a plurality of the chance cards identify at least one of income or a discount correlated to fixed expense.

20. The computer implemented role playing game of claim 17, wherein a majority of the chance cards identify expenses.

21. The computer implemented role playing game of claim 11, wherein the fictitious cash value of the supply of play money correlates to a typical after tax salary of the hypothetical low income individual.

22. A method for playing a role playing game comprising:
a) providing at least one identity card providing information relating to a hypothetical low income individual,
b) providing a plurality of expense cards each having an associated expense value, and a supply of play money having a fictitious cash value,
c) drawing a chance card having at least one instruction and responding to the instruction,
d) allocating at least a portion of the play money towards the expense value of at least one expense card,
e) repeating steps c and d until all of the expense cards have an associated play money allocation or the play money is depleted.

23. The method of claim 22 wherein the identity card provides information related to at least one of the hypothetical low income individual's current employment status, marital status and family status.

24. The method of claim 22 wherein the expense cards identify fixed expenses associated with a typical month in the life of the hypothetical low income individual.

25. The method of claim 24, wherein the expense cards identify fixed expenses that are at least one of housing expenses, utility expenses, transportation expenses, child care expenses, health care expenses, food expenses, telephone expenses and miscellaneous expenses.

26. The method of claim 24, wherein the expense cards identify fixed expenses that collectively have a value that exceeds the fictitious cash value of the supply of play money.

27. The method of claim 22, wherein the chance cards identify variable events associated with a typical month in the life of the hypothetical low income individual.

28. The method of claim 27, wherein a plurality of the chance cards identify variable expenses that are at least one of mandatory expenses, optional expenses, income and bad news.

29. The method of claim 27, wherein a plurality of the chance cards identify at least one of income or a discount correlated to fixed expense.

30. The method of claim 27, wherein a majority of the chance cards identify expenses.

31. The method of claim 22, wherein the fictitious cash value of the supply of play money correlates to a typical after tax salary of the hypothetical low income individual.
